(19) United States
(12) Patent Application Publication
(10) Pub. No.: US 2015/0142590 A1
(43) Pub. Date: May 21, 2015

(54) User-Specific Point-of-Sale Network Recommendations Based on Connection Quality Data

(71) Applicants: James Christopher Gray, Redmond, WA (US); Triptpal Singh Lamba, Bothell, WA (US); David Neil MacDonald, Seattle, WA (US); Sidharth Uday Nabar, Seattle, WA (US)

(72) Inventors: James Christopher Gray, Redmond, WA (US); Triptpal Singh Lamba, Bothell, WA (US); David Neil MacDonald, Seattle, WA (US); Sidharth Uday Nabar, Seattle, WA (US)

(21) Appl. No.: 14/081,184

(22) Filed: Nov. 15, 2013

(51) Int. Cl. G06Q 30/06; G06Q 20/20

(52) U.S. Cl. CPC G06Q 30/0631; G06Q 20/202
USPC 705/21

(57) ABSTRACT

Embodiments recommend network coverage for a user based on a connection history of the user and connection quality data for networks. The connection history describes connection of the user over time via at least one mobile computing device to one or more networks. Connection quality data describing performance of the networks is obtained. Based on the connection history and the connection quality data, recommended network coverage for the user is defined. In some embodiments, a customized out-of-the-box experience (OOBE) for wireless services is provided for the user.

### BACKGROUND

With the increased popularity of smart telephones, tablets, and other mobile devices, there has been an increase in the quantity of wireless access points (WAPs) and data plans available to these mobile devices. However, different WAPs often provide different performance, and different data plans have different costs and features. Choosing an amount and cost of network coverage to suit a particular user is difficult with existing systems.

For example, when the user visits a retail store to purchase a wireless device and wireless service, the user has to browse multiple data plans, each having multiple different features such as the amount of network data included for consumption and the types of networks available under the data plan. It is difficult for the user to select a data plan that provides network coverage appropriate for the needs of the user while minimizing costs.

### SUMMARY

Embodiments of the disclosure provide a customized out-of-the-box experience (OOBE) for a user of a mobile computing device. A computing device receives a connection history of the user. The connection history describes connection of the user over time via at least one mobile computing device to at least one of a plurality of networks available at one or more locations. The computing device accesses connection quality data describing performance of the plurality of networks available at the one or more locations. The computing device defines recommended network coverage for the user based on the received connection history and the accessed connection quality data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a point-of-sale device operating at a point-of-sale location to provide a customized out-of-the-box experience (OOBE) for a user.

FIG. 2 is an exemplary block diagram illustrating a computing device executing computer-executable components to define recommended network coverage for a user.

FIG. 3 is an exemplary flow chart illustrating operation of a computing device to define recommended network coverage for a user based on a connection history of the user and connection quality data.

FIG. 4 is an exemplary flow chart illustrating operation of a computing device to receive a connection history from a user to recommend network coverage for the user.

Corresponding reference characters indicate corresponding parts throughout the drawings.

### DETAILED DESCRIPTION

Referring to the figures, embodiments of the disclosure provide a customized point-of-sale experience for a user 204. In some embodiments, data describing the user 204 is obtained and used, along with connection quality data 212, to recommend and/or customize network coverage. The obtained data includes user expectations (e.g., types of activities commonly engaged in), previous usage information (e.g., a mobility pattern of the user 204, usage types, usage amounts, etc.), frequently visited access points and dwell times, geographic regions of interest, and the like. The connection quality data 212 describes the performance of networks, and is crowdsourced from a plurality of the users 204. Some embodiments recommend a data plan operable with a particular set or quantity of wireless access points (WAPs) based on the user data. Aspects of the disclosure may further predict the estimated cost per billing cycle of the recommended data plan for the user 204. Data supporting the recommended network coverage are loaded into a new device of the user 204 to enhance the out-of-the-box experience, and/or loaded into existing devices of the user 204.

By defining the recommendations based in part on the connection quality data 212 relevant to the particular user 204, aspects of the disclosure further improve the network experience for that user 204. Additionally, aspects of the disclosure may reduce the cost of network access by favoring WAPs with lower cost than other WAPs. For example, wireless fidelity (Wi-Fi) access points are favored over cellular connections whenever feasible, and with as little user 204 intervention as possible. In general, aspects of the disclosure utilize the lowest cost networks that meet the needs of the user 204, and automatically when possible.

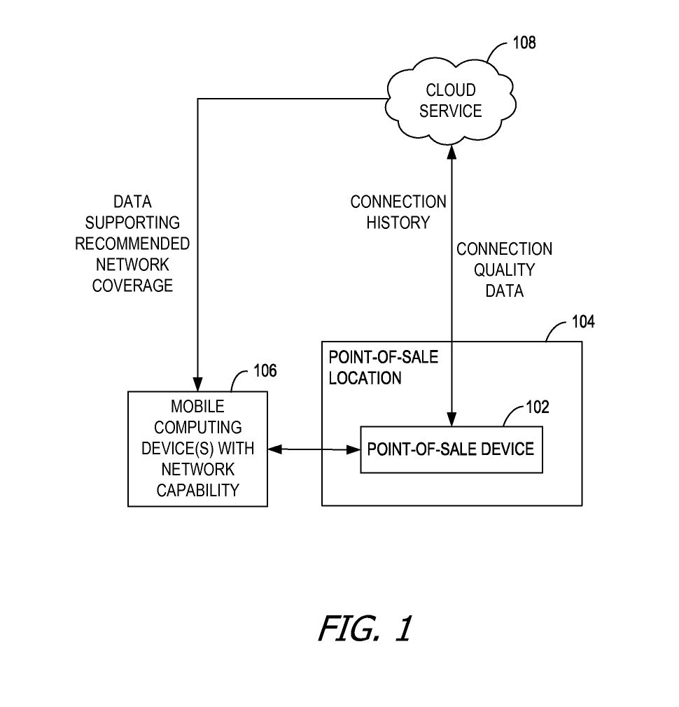

Referring next to FIG. 1, an exemplary block diagram illustrates a point-of-sale device 102 operating at a point-of-sale location 104 to provide a customized out-of-the-box experience (OOBE) for the user 204. In the example of FIG. 1, the point-of-sale device 102 includes a kiosk and the point-of-sale location 104 includes a merchant location. However, the point-of-sale device 102 may include any kind of computing device 202 and/or a terminal connected to a computing device 202, and the point-of-sale location 104 may include any location at which the user 204 interfaces with the point-of-sale device 102. In another example, the point-of-sale device 102 includes a mobile telephone of the user 204 and the point-of-sale location 104 includes a home of the user 204.

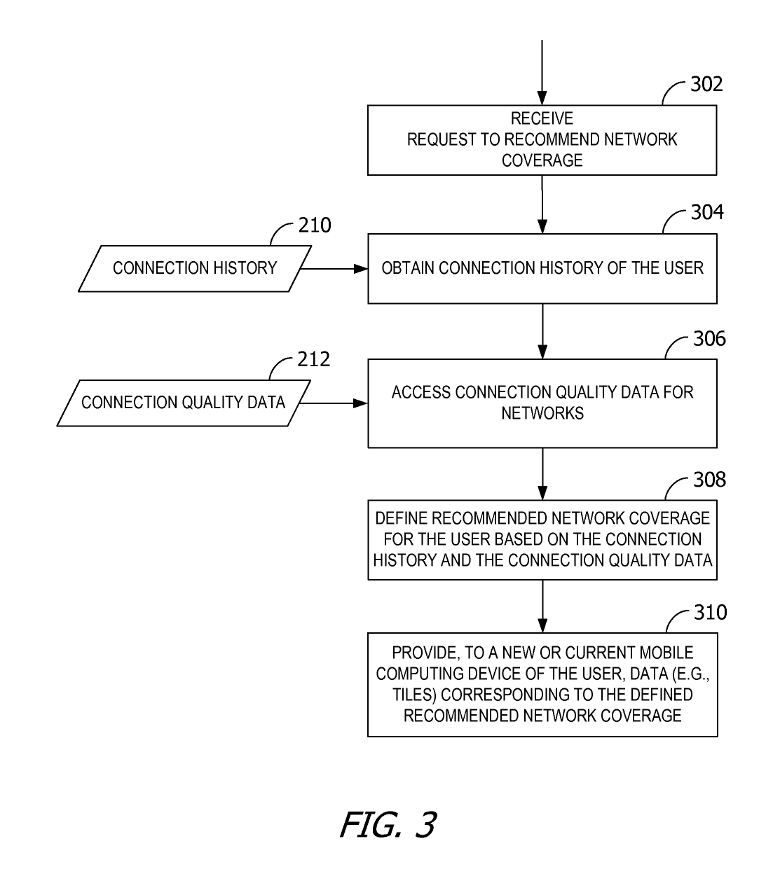

One or more computing devices of the user may interface with the point-of-sale device 102. In the example of FIG. 1, one or more mobile computing devices 106 with network capability interface with the point-of-sale device 102, such as when the user 204 visits the merchant location to purchase wireless services for the mobile computing device 106. The point-of-sale device 102 communicates with a cloud service 108, based on input from the mobile computing device 106, to recommend network coverage for the user 204. For example, the point-of-sale device 102 receives a connection history 210 of the user 204, accesses connection quality data 212, and recommends the network coverage, as described further with reference to FIG. 3 below.

In some embodiments, the point-of-sale device 102 may be another mobile computing device (e.g., associated with the merchant location).

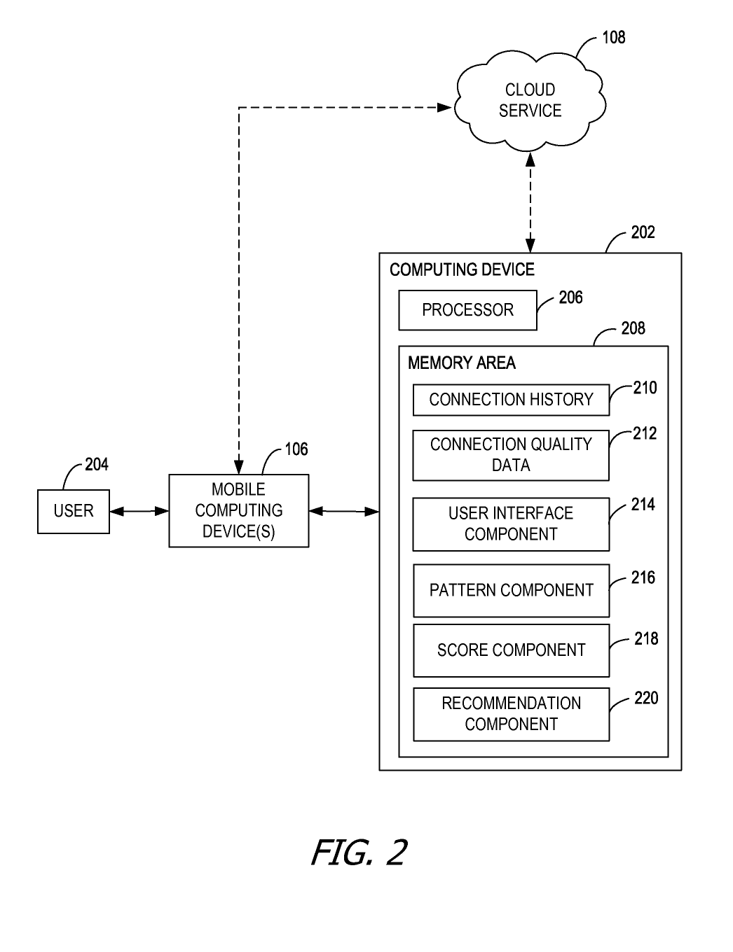

Referring next to FIG. 2, an exemplary block diagram illustrates the computing device 202, such as the point-of-sale device 102 in FIG. 1, executing computer-executable components to define recommended network coverage for the user 204. For example, the computing device 202 provides a customized out-of-the-box experience for the user 204 when purchasing a new mobile telephone and wireless service. In other examples, the computing device 202 operates to change existing wireless service on a current mobile telephone of the user 204. In general, the computing device 202 recommends network coverage for the user 204 based on data describing the connection history 210 of the user 204 and based on connection quality data 212 describing networks available to the user 204. The connection history 210 includes any data provided by the user 204 and/or device of the user 204 that enables aspects of the disclosure to understand usage patterns of the user 204. The connection history 210 may be provided from storage associated with the cloud service 108 and/or any device of the user 204. For example, the computing device 202 may receive an oral or written description of how, where, and/or when the user 204 uses, or plans to use, the mobile computing device 106 (e.g., voice calls, text messages, media streaming, etc.).

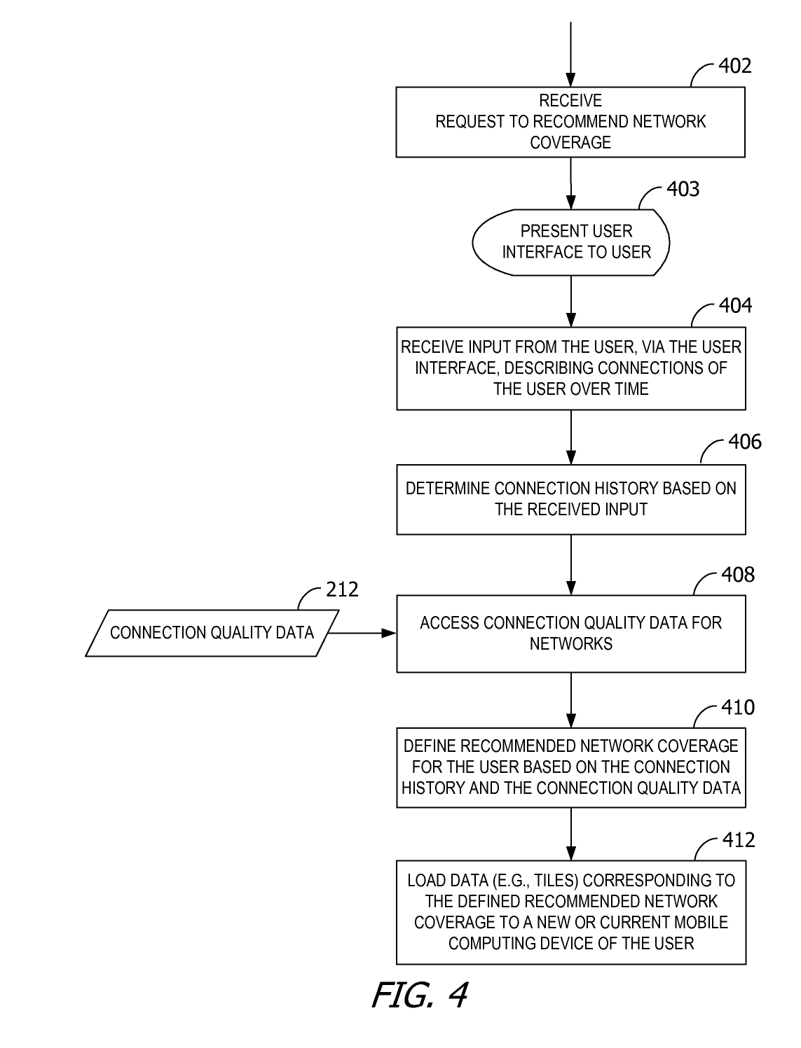

The computing device 202 represents any device executing instructions (e.g., as application programs, operating system functionality, or both) to implement operations and functionality such as illustrated in FIG. 3 and/or FIG. 4. The computing device 202 may include a mobile computing device or any other portable device. In some embodiments, the mobile computing device includes a mobile telephone, laptop, tablet, computing pad, netbook, gaming device, and/or portable media player. The computing device 202 may also include less portable devices such as desktop personal computers, kiosks, and tabletop devices. Additionally, the computing device 202 may represent a group of processing units or other computing devices. The computing device 202 may also represent a terminal connected to a remote computing device (e.g., in a cloud).

In some embodiments, the computing device 202 has at least one processor 206 and a memory area 208. The processor 206 includes any quantity of processing units, and is programmed to execute computer-executable instructions for implementing aspects of the disclosure. The instructions may be performed by the processor 206 or by multiple processors executing within the computing device 202, or performed by a processor external to the computing device 202. In some embodiments, the processor 206 is programmed to execute instructions such as those illustrated in the figures (e.g., FIG. 3 and/or FIG. 4).

In some embodiments, the processor 206 represents an implementation of analog techniques to perform the operations described herein. For example, the operations may be performed by an analog computing device and/or a digital computing device.

The computing device 202 further has one or more computer readable media such as the memory area 208. The memory area 208 includes any quantity of media associated with or accessible by the computing device 202. The memory area 208 may be internal to the computing device 202 (as shown in FIG. 2), external to the computing device 202 (not shown), or both (not shown). In some embodiments, the memory area 208 includes read-only memory and/or memory wired into an analog computing device.

The memory area 208 stores, among other data, one or more applications. The applications, when executed by the processor 206, operate to perform functionality on the computing device 202. The applications may communicate with counterpart applications or services such as web services accessible via a network. For example, the applications may represent downloaded client-side applications that correspond to server-side services executing in a cloud.

The memory area 208 further stores the connection history 210 of the user 204. The connection history 210 is maintained or otherwise stored, for example, by the cloud service 108. In general, the connection history 210 describes the network usage characteristics and/or usage patterns of the user 204. The connection history 210 may also represent one or more signals obtained or derived from the mobile computing device 106. For example, the connection history 210 includes identifiers for a set of networks to which the mobile computing device 106 of the user 204 has previously connected, such as the service set identifier (SSID) and/or basic service set identification (BSSID) of each network. The connection history 210 may also include the locations of the previous connections, durations of each of the connections, and the like. The connection history 210 may describe the connections of the current mobile computing device 106 of the user 204 and/or a plurality of computing devices (e.g., mobile telephone, tablet, etc.).

In some embodiments, the connection history 210 is provided by the user 204. For example, the user 204 connects the mobile computing device 106 to the computing device 202 (e.g., wirelessly or via a wire) to automatically transmit the connection history 210. In another example, the user 204 manually inputs the connection history 210 to the computing device 202. In still another example, the user 204 presents the connection history 210 to an operator (e.g., salesperson) of the computing device 202, who then inputs data into the computing device 202 on behalf of the user 204.

In other embodiments, the connection history 210 is obtained from the cloud service 108. For example, based on an identifier associated with the user 204 and/or mobile computing device 106 (e.g., login, password, personal identification number, mobile telephone number, media access control address, etc.), the computing device 202 requests and receives the connection history 210 from the cloud service 108. In embodiments in which a one-way hash of the identifier is stored with the connection history 210 of the user 204 by the cloud service 108 (e.g., to maintain anonymity and privacy for the user 204), the computing device 202 receives the identifier from the user 204, recomputes the hash of the identifier, and obtains the connection history 210 for the user 204 using the hash as an index or filter criteria or tag. After obtaining the connection history 210 from the cloud service 108, the connection history 210 is stored in the memory area 208.

Alternatively or in addition, the connection history 210 may be obtained from one or more mobile operators. For example, the user 204 may subscribe to data plans from the mobile operators, and those mobile operators collect, maintain, and provide network data consumption statistics relating to use of those data plans.

The memory area 208 further stores the connection quality data 212 describing performance of a plurality of networks providing connectivity to the user 204. The connection quality data 212 represents, and/or is derived from, data that has been collected from a plurality of networks, such as a plurality of Wi-Fi hotspots and cellular data networks, as seen by a plurality of the mobile computing devices (e.g., mobile computing devices 106). The connection quality data 212 may be used as a model that describes the quality characteristics of the networks. For example, the connection quality data 212 includes a score for each of the networks and connections made over those networks, with the score generally representing the quality of experience to be expected when using that network (e.g., throughput, latency, reliability, etc.). The connection quality data 212, or portions thereof, may be downloaded from the cloud service 108 on demand, or periodically (e.g., nightly). In some embodiments, the connection quality data 212 is derived, in whole or in part, from data obtained through passive operation and/or active testing.

Passive operation includes crowdsourcing data from a plurality of user computing devices (e.g., from a plurality of the users 204). Crowdsourcing includes the plurality of user computing devices transmitting the data to the cloud service 108, or other central service, that is compiling and/or hosting the connection quality data 212. The data crowdsourced from the user computing devices includes, but is not limited to, network context, device context, user context, and/or quality of experience data. Network context includes, for example, identifiers of the networks to which the mobile computing device 106 has connection, and statistical data (e.g., transmission control protocol data) about those networks and connections such as protocol, band, and encryption. The device context includes, for example, which applications were using which networks, session identifier, other applications installed, battery use, signal strength, weather, location, and the like. The user context includes, for example, profile data such as user name, data plan subscription information (e.g., mobile operator), and the like.

In some embodiments, the applications and/or operating system on each of the user computing devices generates and reports the data. For example, after the user 204 opts in to crowdsourcing, the mobile computing device 106 detects nearby hotspots, cellular networks, and other wireless access points and their characteristics throughout the day. The mobile computing device 106 collects data describing these networks (whether connected or just scanned) and characteristics, and periodically uploads the data to the cloud service 108 without the user 204 being noticeably impacted by the activity. Alternatively or in addition, the mobile computing device 106 collects the data in response to particular events (e.g., connecting/disconnecting from networks during calls or data transfer), after pre-defined time intervals, and/or in response to a command from the cloud service 108. The mobile computing device 106 may also suspend data collection in response to receiving a throttling request from the cloud service 108, in respond to device context (e.g., low battery), and/or in response to a manual override from the user 204.

Alternatively or in addition, the user 204 may actively provide quality of experience data. For example, the user 204 may rate each connected network via a “Rate My Network” application executing on the mobile computing device 106. The rating may be based on call quality, such as during voice over Internet Protocol (VoIP) calls.

In some examples, the crowdsourced data includes a dwell time on each network (e.g., the amount of time the user 204 spends on each network), the quantity of data (e.g., in bytes) sent and received by the mobile computing device 106, the reason for disconnecting from each network (e.g., out of range, manually disconnect, etc.), upward and downward bandwidth, retransmit rate (e.g., packet loss), latency, jitter, and the like. The crowdsourced data may also be aggregated across connections.

In some embodiments, active testing includes performing a test on the network (e.g., a test call over VoIP, or other network probing) and collecting statistics such as quality of experience, retransmit rate, latency, jitter, etc.

The data collected to generate the connection quality data 212 may be tagged, such as by identifying high priority data versus low priority data, adding time-to-live data, etc. The time-to-live tags enables forced purging of data from the cloud service 108.

Exemplary data collected from the mobile computing device 106 to produce the connection quality data 212 is illustrated in Appendix A.

The connection quality data 212 stored by the cloud service 108 is used by the computing device 202, as described with reference to FIG. 3 and FIG. 4, to expose the abilities of each of the networks to applications and services on the mobile computing device 106 of the user 204.

The memory area 208 further stores one or more computer-executable components. Exemplary components include a user interface component 214, a pattern component 216, a score component 218, and a recommendation component 220. Operation of these components is described with reference to FIG. 4.

The computing device 202 further includes a network interface supporting communication among the computing device 202, the mobile computing device 106, and the cloud service 108 using any protocol or mechanism over any wired or wireless connection. The computing device 202 may further include a user interface for displaying data to the user 204 and receiving data from the user 204. The user interface may include one or more of the following to provide data to the user 204 or receive data from the user 204: a touch screen display or natural user interface, speakers, a sound card, a camera, and a microphone.

In some scenarios, the user 204 visits the computing device 202 at the merchant location to obtain wireless services, such as cellular, Wi-Fi, whitespace, satellite, and/or the like. The user 204 interacts with the computing device 202 via the mobile computing device 106 (e.g., wireless telephone, tablet, etc.) associated with the user 204. Based on the connection history 210 of the user 204 and the connection quality data 212, the computing device 202 recommends network coverage (e.g., a coverage plan) for the user 204, as described next with reference to FIG. 3 and FIG. 4.

While some embodiments are described with inclusion of the cloud service 108 (e.g., obtaining the connection history 210 and/or connection quality data 212 therefrom), aspects of the disclosure are operable without the cloud service 108. In such aspects, the connection history 210 is obtained from the mobile computing device 106, and data supporting the recommended network coverage is provided from the computing device 202 to the mobile computing device 106.

Referring next to FIG. 3, an exemplary flow chart illustrates operation of the computing device 202 to define recommended network coverage for the user 204 based on the connection history 210 of the user 204 and the connection quality data 212. While the operations illustrated in FIG. 3 are described as being performed by the computing device 202 associated with the point-of-sale location 104, aspects of the disclosure contemplate performance of the operations by entities other than the computing device 202, such as the cloud service 108.

At 302, the computing device 202 receives a request (e.g., from the user 204) to recommend network coverage for one or more of the mobile computing devices 106 of the user 204. In response to the received request, the computing device 202 obtains, accesses, and/or receives the connection history 210 of the user 204 at 304. The connection history 210 describes connection of the user 204 over time via the mobile computing device(s) 106 of the user 204 to one or more networks. In some embodiments, the connection history 210 describes network usage characteristics of the user 204. For example, the user 204 may connect to Wi-Fi at a first location (e.g., home network), cellular while commuting to work (e.g., one or more cellular towers), and then Wi-Fi again at a second location (e.g., work network). The connection history 210 may also describe an amount of data consumed, and when and where the data was consumed.

In some embodiments, receiving the connection history 210 comprises receiving identification of an Internet service provider (ISP), a cable provider, and/or any entity providing Wi-Fi access to devices of the user 204. For example, the computing device 202 receives the connection history 210 by analyzing the mobile computing device 106 of the user 204 to obtain the connection history 210, requests the connection history 210 from the cloud service 108 (e.g., access a cloud-based account of the user 204), and/or requests the connection history 210 directly from the user 204.

In some of the embodiments in which the computing device 202 receives the connection history 210 from the user 204, the computing device 202 presents one or more user profiles to the user 204 and receives, from the user 204, a selection of at least one of the user profiles. Aspects of the disclosure are operable with any user profiles that describe network usage characteristics of the user 204, such as an amount of data consumed during a billing cycle and locations of the consumption. For example, one user profile may correspond to users 204 who primarily use cellular networks, while another user profile may correspond to users 204 who primarily use Wi-Fi networks. In another example, one user profile may correspond to users 204 who consume large amounts of data during each billing cycle, while another user profile may correspond to users 204 who consume small amounts of data during each billing cycle.

Alternatively or in addition, the computing device 202 determines the connection history 210 by presenting a set of questions to the user 204 (e.g., in the form of a questionnaire) to ascertain the network usage characteristics of the user 204. The computing device 202 receives input from the user 204, which is used to determine the connection history 210.

At 306, the computing device 202 accesses the connection quality data 212 describing performance of the networks from the obtained connection history 210. The connection quality data 212 may be stored locally to the computing device 202 and/or accessible from the cloud service 108. The computing device 202 selectively obtains the connection quality data 212 for the networks that may be of relevance or interest to the user 204. For example, the computing device 202 obtains the connection quality data 212 describing the networks visited by the user 204 based on the obtained connection history 210. While the computing device 202 obtains only the connection quality data 212 associated with the particular user 204 in some embodiments, other embodiments contemplate obtaining the connection quality data 212 generated from data collected from a plurality of the users 204.

The computing device 202 may also attempt to identify other networks at the locations visited by the user 204. For example, to continue the above example, the computing device 202 may obtain the connection quality data 212 that describes other networks available at the first location, along the commute route, and at the second location.

In some embodiments, the computing device 202 attempts to identify other networks around the locations visited by the user 204 by determining a mobility pattern of the user 204 based on the received connection history 210. The mobility pattern describes the movement of the user 204 around the locations. In some embodiments, determining the mobility pattern comprises receiving a start location and a destination from the user 204, and calculating one or more routes between the start location and the destination (e.g., including an expected route). The computing device 202 then identifies the networks available along the calculated routes, and obtains the connection quality data 212 describing those networks.

Determining the mobility pattern may also include, for example, determining frequently visited locations of the user 204 (e.g., from check-in data at the locations, calendar events, etc.). In some embodiments, the computing device 202 determines the frequently visited locations of the user 204 by presenting a map to the user 204 and receiving, from the user 204, identification of locations on the map. Those skilled in the art will note that the locations may include not only locations previously visited by the user 204, but also locations the user 204 may expect to visit (e.g., when preparing to travel or move to a new city).

At 308, the computing device 202 defines recommended network coverage for the user 204 based on the obtained connection history 210 and based on the connection quality data 212. The recommended network coverage enables the mobile computing device 106 to have access to the lowest cost networks that meet the needs of the user 204 and the applications of the user 204 at all times. Having access to the lowest cost networks, and connecting automatically when possible, reduces costs for the user 204. For example, having access to enough Wi-Fi networks allows the mobile computing device 106 to offload data from cellular networks to the Wi-Fi networks as aggressively as possible with minimal user 204 interaction to reduce network data costs (e.g., when the Wi-Fi networks have less cost than the cellular networks).

In some embodiments, the recommended network coverage includes the networks identified in the connection history 210. The computing device 202 selects or creates a data plan for the user 204 that includes access to these networks. Based on usage characteristics of the user 204 (e.g., amount of data consumed, bandwidth, usage day/time, etc. from the connection history 210), the computing device 202 may further qualify the selected data plan with recommended usage characteristics and/or options (e.g., an amount of data per month, upload/download bandwidth speed, monthly premium cost, etc.).

In general, the computing device 202 selects a plurality of network types, such as cellular, Wi-Fi, whitespace, and satellite. In some embodiments, the recommended network coverage may further include networks other than, or in addition to, those previously visited by the user 204. These other networks may provide better performance and/or lower cost to the user 204, as determined from the connection quality data 212. The computing device 202 may identify these other networks by comparing the connection quality data 212 for the networks previously visited by the user 204 with the connection quality data 212 for other networks, and selecting the networks that provide the better performance and/or lower cost. As an example, the computing device 202 may identify additional Wi-Fi networks that are available at locations visited by the user 204 (e.g., the locations being determined from the connection history 210), and recommend providers of those Wi-Fi networks.

In some embodiments, the computing device 202 identifies one or more geographic areas corresponding to the recommended network coverage. Exemplary geographic areas include metropolitan service areas, rectangular geographic areas (e.g., areas that are about one mile long by one mile wide), or other defined areas. As an example, the computing device 202 identifies the particular data structures corresponding to the geographic areas associated with the recommended network coverage. Exemplary data structures include tiles storing data corresponding to the defined recommended network coverage. In some embodiments, the tile is a data structure that associates a set of different networks, all of which are associated with a particular location. For example, each tile stores the connection quality data 212 describing one or more networks within a particular geographic area (e.g., within one square mile). As an example, each tile stores information such as a service set identifier (SSID) and basic service set identifier (BSSID) of network access points, the locations of the network access points, and the connection quality data 212 of those network access points. The tiles may further store attributes of the connection quality data 212, such as a time of day, an expiration value, and/or a confidence level (e.g., an amount or quantity of data input to calculate the connection quality data 212). In some embodiments, the expiration value for the connection quality data 212 for a particular network is based on the stability of that particular network. One or more of the tiles may be downloaded by the computing device 202 for caching.

Recommending the network coverage also includes, in some embodiments, assessing and recommending coverage for multiple different devices of the user 204. For example, the computing device 202 receives identification of a list or set of the different devices of the user 204, along with hardware and/or software characteristics of each of those devices (e.g., type/version of antenna, cellular radio, network interface drivers, etc.). The computing device 202 then recommends the network coverage based on, in part, the different devices of the user 204. For example, if at least one of the devices supports Wi-Fi, the recommended network coverage may include Wi-Fi coverage. In another example, if at least one of the devices supports virtual private network (VPN) tunneling, the recommended network coverage may include VPN functionality. Conversely, if none of the devices support Wi-Fi, the recommended network coverage omits Wi-Fi coverage.

The recommended network coverage (e.g., data plan, usage characteristics, etc.) may be presented to the user 204 for approval. For example, an operator of the computing device 202 may present the recommended network coverage to the user 204, or the recommended network coverage may be displayed to the user 204 on the mobile computing device 106 of the user 204. After approval from the user 204, the computing device 202 provides the user 204 with data corresponding to the recommended network coverage at 310. The computing device 202 may provide the data to one or more currently-owned mobile computing devices 106 of the user 204, and/or may provide the data to a new mobile computing device 106 of the user 204 (e.g., purchased at the point-of-sale location 104, or purchased elsewhere and brought to the point-of-sale).

In some embodiments, the computing device 202 directly pre-loads the data onto the mobile computing device 106 through a wireless and/or wired connection (e.g., via BLUETOOTH brand communication, near-field communication, universal serial bus transfer, etc.). Alternatively or in addition, the computing device 202 directs the mobile computing device 106 to download the data from the cloud service 108. In some embodiments, the data corresponding to the recommended network coverage is embodied in one or more data structures, such as tiles, downloaded to the mobile computing device 106.

The data corresponding to the recommended network coverage includes, for example, identification of WAPs, connection quality information for the WAPs, instructions for connecting to the WAPs, authentication information (e.g., login and/or password) for the WAPs, SSIDs of the WAPs, and/or BSSIDs of the WAPs.

Referring next to FIG. 4, an exemplary flow chart illustrates operation of the computing device 202 to receive the connection history 210 from the user 204 to recommend network coverage for the user 204. While the operations illustrated in FIG. 4 are described as being performed by the computing device 202 associated with the point-of-sale location 104, aspects of the disclosure contemplate performance of the operations by entities other than the computing device 202, such as the cloud service 108. Further, while some of the operations illustrated in FIG. 4 are described as being performed by computer-executable components (e.g., the components illustrated in FIG. 2) stored on computer storage media, aspects of the disclosure contemplate performance of the operation by any computer-executable instructions.

At 402, the computing device 202 receives a request (e.g., from the user 204 or mobile computing device 106 of the user 204) to recommend network coverage. At 403, the computing device 202 presents a user interface to the user 204 (e.g., via the user interface component 214). For example, the user 204 may interact with the user interface executing on the computing device 202. In another example, the computing device 202 provides the user interface to the mobile computing device 106 for display (e.g., via a web browser). At 404, the user interface component 214, when executed by the processor 206, causes the processor 206 to receive input from the user 204 via the user interface. The input describes the connections of the user 204 over time via one or more of the mobile computing devices 106 of the user 204 to at least one of the networks. For example, the user interface component 214 may present questions to the user 204 (e.g., multiple choice) and receive answers from the user 204. The questions may relate to the connections, network usage characteristics and/or patterns, and the like.

At 406, the pattern component 216, when executed by the processor 206, causes the processor 206 to determine the connection history 210 of the user 204 based on the input received by the user interface component 214. In examples in which the user interface component 214 presents questions to the user 204, the computing device 202 defines the connection history 210 based on the answers provided by the user 204.

At 408, the score component 218, when executed by the processor 206, causes the processor 206 to access the connection quality data 212. In some embodiments, the connection quality data 212 describes performance of networks available and of interest to the user 204 at one or more locations. For example, given the input and the connection history 210 of the user 204, one or more locations are identified. The locations may be defined by geographic area, such as by city, zip code, longitude/latitude, tiles, and the like. The tiles may correspond to contiguous rectangular geographic areas each of a uniform size (e.g., one mile by one mile), in some embodiments. The computing device 202 identifies the networks available in the identified locations. For example, the computing device 202 uses the locations as an index into a database or other data source storing correlations between locations and networks to determine the networks available within the identified locations. The score component 218 accesses the connection quality data 212 for the determined networks. For example, the score component 218 obtains the connection quality data 212 from the cloud service 108.

In some embodiments, the connection quality data 212 is specific to the type of user device (e.g., mobile computing device 106), or characteristics thereof. For example, the connection quality data 212 obtained by the score component 218 may be different for the mobile computing devices 106 that have different hardware and/or software configurations (e.g., different antennas). The recommendation component 220, as next described, considers the device-specific connection quality data 212 when defining the recommended network coverage.

At 410, the recommendation component 220, when executed by the processor 206, causes the processor 206 to define recommended network coverage for the user 204 based on the connection history 210 determined by the pattern component 216 and based on the connection quality data 212 accessed by the score component 218. Defining the recommended network coverage in the example of FIG. 4 occurs similar to the network coverage recommendation process described with reference to FIG. 3. For example, the recommendation component 220 defines the recommended network coverage by selecting one of a plurality of pre-defined data plans for the user 204, or creating a monthly data plan specifically for the user 204. Defining the recommended network coverage may also include recommending, based on the connection history 210 of the user 204 and the connection quality data 212, one or more data plan options. An exemplary data plan option includes an option to temporarily increase network bandwidth or speed on demand.

At 412, the computing device 202 loads data corresponding to the defined recommended network coverage to one or more mobile computing devices 106 of the user 204. For example, the data may be loaded to a current mobile computing device 106 of the user 204, a newly-purchased mobile computing device 106, or both. Loading the data includes a direct transfer from the computing device 202 to the mobile computing device 106, in some embodiments. In other embodiments, the computing device 202 embodies the data in one or more tiles for storage by the cloud service 108, which are then downloaded by the mobile computing device 106.

### Additional Examples

In some embodiments, to further improve the OOBE experience for the user 204, the mobile computing device 106 automatically connects to one of the networks after the data supporting the recommended network coverage has been loaded onto the mobile computing device 106. For example, the mobile computing device 106 may automatically connect to a Wi-Fi hotspot while still in the point-of-sale location 104. Further, the mobile computing device 106 may initiate a test VoIP call using the Wi-Fi hotspot.

While some embodiments have been described herein with reference to the data plan (e.g., part of the recommended network coverage) having a set of minutes and/or bytes for consumption over the networks, the data plans may also be defined in other units. For example, the data plan may be assigned a quantity of points that are used or expended when the user 204 connects to the networks and transfers data over the networks. In some embodiments, the user 204 may increase the balance of points on the data plan during the billing cycle by completing search challenges, obtaining gaming achievements, or obtaining other social or community awards.

Alternatively or in addition, in embodiments in which the recommended network coverage defines a cost for the data plan, the currency of the cost may be described in any units. For example, the cost may be described in U.S. dollars and/or a virtual currency such as points. In a virtual currency example, the computing device 202 may determine the monthly premium for the data plan by determining a quantity of points to be applied during each billing cycle. In some embodiments, the user 204 may earn additional points by completing searches, challenges, or other tasks.

In some embodiments, recommending network coverage further includes recommending a particular user computing device for use by the user 204. For example, aspects of the disclosure may identify one or more mobile telephones with features that support the recommended network coverage for that user 204. As a particular example, if the recommended network coverage includes a set of Wi-Fi access points, aspects of the disclosure recommend mobile telephones that have a Wi-Fi network interface. In another particular example, if the recommended network coverage includes a virtual private network (VPN) connection, aspects of the disclosure recommend mobile telephones that have a network interface that supports VPN connections.

Aspects of the disclosure contemplate providing Wi-Fi usage tips as part of the recommended network coverage given at the point-of-sale location 104 and/or elsewhere. Further, these usage tips may be provided at the time of point-of-sale and/or anytime after. The usage tips may surface as notifications, on demand, and/or as “did you know” style messages on the bill from a service provider. Exemplary usage tips include, but are not limited to, statements such as:
“You make calls from this location several times a week, and this location has available Wi-Fi. If you connect to Wi-Fi at this location, you could save $19 per month.”
“You typically make international calls from this map location every Sunday. If you waited to make the call until you go to a Wi-Fi hotspot, you could save $15 on each call.”
“Over 50% of your data charges are through Application A using cellular data. Consider using Application A only while on Wi-Fi to save as much as $15 per month.”

At least a portion of the functionality of the various elements in FIG. 1 and FIG. 2 may be performed by other elements in FIG. 1 and/or FIG. 2, or an entity (e.g., processor, web service, server, application program, computing device, etc.) not shown in FIG. 1 or FIG. 2.

In some embodiments, the operations illustrated in FIG. 3 and FIG. 4 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The term “roaming” as used herein refers, in some embodiments, to connectivity provided outside a subscriber's home zone that may be subject to additional tariffs, fees, or constraints. Roaming service may or may not be provided by the same mobile operator. The term “Wi-Fi” as used herein refers, in some embodiments, to a wireless local area network using high frequency radio signals for the transmission of data. The term “BLUETOOTH” as used herein refers, in some embodiments, to a wireless technology standard for exchanging data over short distances using short wavelength radio transmission. The term “cellular” as used herein refers, in some embodiments, to a wireless communication system using short-range radio stations that, when joined together, enable the transmission of data over a wide geographic area.

While no personally identifiable information is tracked by aspects of the disclosure, embodiments have been described with reference to data monitored and/or collected from the users 204. In some embodiments, notice may be provided to the users 204 of the collection of the data (e.g., via a dialog box or preference setting) and users 204 are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. In some embodiments, computer storage media are implemented in hardware. Exemplary computer storage media include hard disks, flash drives, and other solid-state memory. In contrast, communication media embody computer readable instructions, data structures, program modules, or other data in a modulated data signal such as a carrier wave or other transport mechanism and include any information delivery media.

Although described in connection with an exemplary computing system environment, embodiments of the disclosure are capable of implementation with numerous other general purpose or special purpose computing system environments, configurations, or devices.

Examples of well-known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user 204 in any way, including from input devices such as a keyboard or pointing device, via gesture input, proximity input (such as by hovering), and/or via voice input.

Embodiments of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for providing a customized point-of-sale experience for the user 204. For example, one or more of the embodiments contemplate means for receiving the connection history 210 of the user 204, accessing the connection quality data 212, defining recommended network coverage for the user 204 based on the received connection history 210 and the accessed connection quality data 212, and providing, to the mobile computing device 106, data corresponding to the defined recommended network coverage.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

### APPENDIX A

Exemplary cellular attributes collected from each of a plurality of mobile computing devices are shown in Table 1 below.

TABLE 1
Exemplary Cellular Attributes During Data Collection.

| Cellular Attribute | Value(s) |
|---|---|
| provider | Mobile operator name |
| MCC | Mobile country code (decimal) |
| MNC | Mobile network code (decimal) |
| LAC | Locale area code (decimal) |
| Cell ID | Value of serving cell |
| Physical Cell ID | Unique code in local area |
| Physical Cell IDs of | Up to 6 cell identifiers that are visible in |
| neighbors | neighborhood. |
| Timing Advance | Length of time for a signal to reach the base |
| | station from the mobile phone. |
| RX | Signal quality of the cell tower |
| Signal Strength | Received signal strength indication (RSSI) |
| CDMA EC/Io | Decibels * 10 |
| SNR | Signal to Noise ratio |
| Network Standard | 2G/3G |
| Air Interface | e.g., for 3G {UMTS, 1xEVDO-DO, HSPA, |
| | HSPA+, WCDMA-TDD, WCDMA-FDD . . . } |
| Radio Channel (ARFCN) | Radio channel for serving cell |
| Roaming State | Roaming on/off/international/local |
| MCC/MNC | Coming from SIM |
| | Coming from network |
| | Coming from other SIMs (and the network they |
| | are camped on to understand roaming) |

What is claimed is:

1. A system for providing a customized point-of-sale experience for a user, said system comprising:
a memory area associated with a computing device, said memory area storing connection quality data describing performance of a plurality of networks available at one or more locations; and
a processor associated with the computing device, the processor being programmed to:
receive a connection history of the user, the connection history describing connection of the user over time via at least one mobile computing device to at least one of the plurality of networks;
access the connection quality data stored in the memory area;
define recommended network coverage for the user based on the received connection history and the accessed connection quality data; and
provide, to the at least one mobile computing device or to a mobile computing device purchased at a point-of-sale location, data corresponding to the defined recommended network coverage.

2. The system of claim 1, wherein the connection history comprises at least one of: crowdsourced quality data, data from cloud storage, data from the memory area, or user input.

3. The system of claim 1, wherein the processor is programmed to provide at least one of a location of a wireless access point (WAP), connection quality information for the WAP, instructions for connecting to the WAP, a password for the WAP, a service set identifier (SSID) of the WAP, or a basic service set identifier (BSSID) of the WAP.

4. The system of claim 1, wherein the processor is further programmed to identify one or more geographic areas corresponding to the defined recommended network coverage.

5. The system of claim 4, wherein the processor is further programmed to identify one or more tiles corresponding to the identified one or more geographic areas, the one or more tiles storing data corresponding to the defined recommended network coverage.

6. The system of claim 1, wherein the defined recommended network coverage includes a data plan identifying one or more of the plurality of networks and an amount of data for consumption on the one or more of the plurality of networks.

7. A method comprising:
receiving, by a computing device, a connection history of a user, the connection history describing connection of the user over time via at least one mobile computing device to at least one of a plurality of networks available at one or more locations;
accessing connection quality data describing performance of the plurality of networks available at the one or more locations; and
defining, by the computing device, recommended network coverage for the user based on the received connection history and the accessed connection quality data.

8. The method of claim 7, wherein receiving the connection history comprises receiving identification of at least one of an Internet service provider (ISP), a cable provider, or wireless fidelity (Wi-Fi) access.

9. The method of claim 7, further comprising determining a mobility pattern of the user based on the received connection history.

10. The method of claim 9, wherein determining the mobility pattern comprises receiving a start location and a destination from the user, and calculating an expected route.

11. The method of claim 9, wherein determining the mobility pattern comprises at least one of determining frequently visited locations of the user, or presenting a map to the user and receiving, from the user, identification of locations on the map.

12. The method of claim 7, wherein receiving the connection history of the user comprises presenting a plurality of user profiles to the user, and receiving, from the user, a selection of at least one of the plurality of user profiles.

13. The method of claim 7, wherein determining the connection history comprises presenting a questionnaire to the user in a user interface, and receiving input from the user in response to the questionnaire.

14. The method of claim 7, wherein receiving the connection history of the user comprises at least one of analyzing the at least one mobile computing device, or accessing a cloud-based account of the user to obtain the connection history.

15. The method of claim 7, wherein defining the recommended network coverage comprises at least one of selecting a quantity of data usage to include in a data plan for the user, selecting a monthly premium for a data plan, or recommending a wireless fidelity (Wi-Fi) provider.

16. The method of claim 7, wherein defining the recommended network coverage comprises selecting a plurality of network types, the plurality of network types being selected from a group consisting of cellular, wireless fidelity (Wi-Fi), whitespace, and satellite.

17. One or more computer storage media embodying computer-executable components, said components comprising:
a user interface component that when executed causes at least one processor to receive input from a user via a user interface, the input describing connections of the user over time via at least one mobile computing device to at least one of a plurality of networks available at one or more locations;
a pattern component that when executed causes at least one processor to determine a connection history of the user based on the input received by the user interface component;
a score component that when executed causes at least one processor to access connection quality data describing performance of the plurality of networks available at the one or more locations; and
a recommendation component that when executed causes at least one processor to define recommended network coverage for the user based on the connection history determined by the pattern component and the connection quality data accessed by the score component.

18. The computer storage media of claim 17, wherein the user interface component further presents questions to the user relating to the connections.

19. The computer storage media of claim 17, wherein the score component obtains the connection quality data from a cloud service.

20. The computer storage media of claim 17, wherein the recommendation component further recommends a data plan option to temporarily increase network bandwidth on demand.
